(19) United States
(12) Patent Application Publication
(10) Pub. No.: US 2012/0287654 A1
(43) Pub. Date: Nov. 15, 2012

(54) LED STREETLAMP INSTALLATION SEAT AND LED STREETLAMP

(75) Inventors: Lin He, Shenzhen (CN); Pulian Pan, Shenzhen (CN); Shengyuan Li, Shenzhen (CN); Jian Li, Shenzhen (CN)

(73) Assignee: SHENZHEN BANG-BELL ELECTRONICS CO., LTD, Shenzhen, Guangdon (CN)

(21) Appl. No.: 13/519,081

(22) PCT Filed: Dec. 25, 2009
(86) PCT No.: PCT/CN09/76087

§ 371 Date: Jun. 25, 2012

(51) Int. Cl. F21S 8/08

(52) U.S. Cl. 362/431

(57) ABSTRACT

An exemplary LED streetlamp installation seat and an LED lamp both has a seat body (1), which has a first accommodating chamber (11) and a second accommodating chamber (12) the first accommodating chamber (11) being used to accommodate a control device (7) for controlling the LED streetlamp and the second accommodating chamber (12) being used to accommodate a fixing device (8) for installing the LED lamp to a lamp-post; and a cover cap, corresponding to the first and the second accommodating chambers (11, 12), which has a first cap (21) and a second cap (22), the first cap (21) and the second cap (22) being hinge-joined. The first cap (21), corresponding to the first accommodating chamber (11), is detachably connected to the first accommodating chamber (11). The second cap (22), corresponding to the second accommodating chamber (21), is detachably connected to the second accommodating chamber (21).

### FIELD OF THE INVENTION

The present invention relates to an element for an LED (Light Emitting Diode) streetlamp, and more particularly to an LED streetlamp installation seat and an LED streetlamp having the LED streetlamp installation seat.

### BACKGROUND

For street and road illumination, high voltage sodium lamp is usually used in conventional technology. In usage, the high voltage sodium lamp has a low optical controllability, low light conversion efficiency, and which produces quite an amount waste of light energy, and a serious light pollution, even though the high voltage sodium lamp has a simply structure and a low cost. Furthermore, the high voltage sodium lamp has a special problem, which is producing strong glare, which will influence the driving safety. However, an LED streetlamp can resolve all the above-described problems.

A conventional LED streetlamp generally includes a frame, an LED lighting module disposed on the frame. For fixing the LED streetlamp on one lamppost, respectively at two sides of a road, an LED streetlamp installation seat is provided at an end of the frame. The LED streetlamp installation seat is used to fix the LED lamp on the lamppost for illuminating the road. The LED streetlamp installation seat includes a first accommodating chamber, adjacent to one end of the frame, which is used to accommodate an electric power and a PCB (Printed Circuit Board), etc. Those are electrically connected to the LED lighting module for controlling the operation of the LED light module. The LED streetlamp further includes a second accommodating chamber, faraway the end of the frame, which is used to accommodate a fixing device for connecting the lamppost. This conventional LED streetlamp has a simply structure. But, in the process of maintaining or repairing the LED streetlamp disposed on the lamp-post, a lot of screws being used at the LED streetlamp are needed to be removed for opening the first or the second accommodating chamber. This process is inconvenient and unsafe for an operator, especially for a steeplejack. And, a high maintenance fee and low work efficiency is produced at the same time. In addition, for improving a waterproof efficiency of the LED streetlamp installation seat, the first accommodating chamber is generally designed to an enclosure space through a sealing cover. Therefore, a large of thermal energy produced by the electrical power and/or the PCB cannot be dispersed to the atmosphere, which will shorten the lifespan of the electrical power and/or the PCB. Accordingly, what are needed are an LED streetlamp installation seat and an LED streetlamp that can overcome the above-described deficiencies.

### SUMMARY OF THE INVENTION

Taking above into consideration, an object of the present invention is to provide an LED streetlamp installation seat that does not need take down a whole cover cap in the repairing process.

Another object of the present invention is to provide an LED streetlamp that can ensure a simple and a high work efficiency in an installation process and a repairing process, and a low cost.

To accomplish the first object, according to the present invention, there is to provide an LED streetlamp installation seat for LED streetlamp. The LED streetlamp installation seat has:

a seat body, having a first accommodating chamber and a second accommodating chamber, the first accommodating chamber being used to accommodate a control device for controlling the LED streetlamp, and the second accommodating chamber being used to accommodate a fixing device for installing the LED lamp to a lamppost; and

a cover cap, corresponding to the first and the second accommodating chambers, which has a first cap and a second cap, the first cap and the second cap being hinge joint;

wherein the first cap, corresponding to the first accommodating chamber, is detachably connected to the first accommodating chamber, and the second cap, corresponding to the second accommodating chamber, is detachably connected to the second accommodating chamber.

To accomplish the first object, according to the present invention, there is further to provide an LED streetlamp installation seat, wherein the first accommodating chamber has a plurality of through holes at a bottom surface thereof, for dispersing heat energy from the control device to atmosphere.

To accomplish the first object, according to the present invention, there is further to provide an LED streetlamp installation seat, wherein the first cap is hinge jointed to the second cap; and a clapboard is provided between the first and the second accommodating chambers, in which the clapboard has two grooves at one sidewall facing to the first accommodating chamber, the two grooves being respectively formed at two sides of the sidewall, respectively adjacent to the connection end of the clapboard and the cover cap; and two strip-shaped blocks are provided at the first cap, corresponding to the two grooves, thus the first cap being detachably connected to the first accommodating chamber through the two strip-shaped blocks inserting into the two grooves, respectively; and two screw holes are provided at two sides of the second cap, thus the second cap being detachably connected to the second accommodating chamber through the cooperation of two screws and the two screw holes, respectively.

To accomplish the first object, according to the present invention, there is further to provide an LED streetlamp installation seat, wherein the first cap is hinge jointed to the second cap; and a clapboard is provided between the first and the second accommodating chambers, in which the clapboard has two strip-shaped blocks at one sidewall facing to the first accommodating chamber, the two strip-shaped blocks being respectively formed at two sides of the sidewall, respectively adjacent to the connection end of the clapboard and the cover cap; and two grooves are provided at the first cap, corresponding to the two strip-shaped blocks, thus the first cap being detachably connected to the first accommodating chamber through the two strip-shaped blocks inserting into the two grooves, respectively; and two screw holes are provided at two sides of the second cap, thus the second cap being detachably connected to the second accommodating chamber through the cooperation of two screws and the two screw holes, respectively.

To accomplish the second object, according to the present invention, there is further to provide an LED streetlamp, which has:

a frame;

an LED lighting module formed on the frame; and

an LED streetlamp installation seat, disposed at one side of the frame, the LED streetlamp installation seat comprising:

a seat body, comprising a first accommodating chamber and a second accommodating chamber, the first accommodating chamber being used to accommodate a control device for controlling the LED streetlamp, and the second accommodating chamber being used to accommodate a fixing device for installing the LED lamp to a lamp-post; and

a cover cap, corresponding to the first and the second accommodating chambers, which has a first cap and a second cap, the first cap and the second cap being hinge-joined;

wherein the first cap, corresponding to the first accommodating chamber, is detachably connected to the first accommodating chamber, and the second cap, corresponding to the second accommodating chamber, is detachably connected to the second accommodating chamber.

To accomplish the second object, according to the present invention, there is further to provide an LED streetlamp wherein the first accommodating chamber has a plurality of through holes at a bottom surface thereof, for dispersing heat energy from the control device to atmosphere.

Comparing to the conventionally technology, the LED streetlamp installation seat of the present invention, utilizes the hinge jointed first cap and the second cap to realize the detachable connection between the first cap and the first accommodating chamber, and the detachable connection between the second cap and the second accommodating chamber. Thus, when the control device needs to be repaired, the first cap can be opened directly through upwardly turning it 90 degrees, relatively to the second cap. Therefore, the electrical power and the PCB can be repaired conveniently. At the end, the operator just need downwardly turn the first cap to the first accommodating chamber. In the whole repairing process, no need of taking down the second cap. Therefore, the repairing process is simple and conveniently, and the efficiency is high. At the same time, in the process of installing LED streetlamp to the lamppost, the operator just needs to loosen the two screws, and upwardly turn the second cap 90 degrees, relative to the first cap. And then, the operator can conveniently fix the fixing device to the lamppost. In the whole installation process, no need of taking down the first cap. Therefore, the installation process is simple and conveniently, and the work efficiency is high. In addition, a plurality of through-holes is provided at a bottom surface of the first accommodating chamber, those can help disperse the heat energy from the control device to the atmosphere. Thus, the heat dispersion efficiency can be enhanced, and the lifespan of the control device can be assured. Furthermore, the first cap and the first accommodating chamber are connected through the cooperation of the strip-shaped blocks and the grooves. Thus, only two screws are needed at the two ends of the first cap and the first accommodating chamber, respectively, for realizing the fixing structure. The second cap and the second accommodating chamber are connected also only through two screws, which can save a lot of screws used at a middle part thereof in conventional technology. Therefore, the LED lamp installation seat can ensure a simple structure and low cost.

Comparing to the conventional technology, the LED lamp of the present invention can realize a convenient repairing and installation processes, through utilization of the LED streetlamp installation seat as described above. Especially, in the installation process, only the second cap needs to be opened, which is easily to assemble.

Other novel features and advantages will become apparent from the following detailed description of preferred and exemplary embodiments when taken in conjunction with the accompanying drawings.

### BRIEF DESCRIPTION OF THE DRAWINGS

FIG. 1 is an isometric exploded diagram of an LED streetlamp installation seat according to a first exemplary embodiment of the present invention.

FIG. 2 is an isometric diagram of an LED streetlamp according to a second exemplary embodiment of the present invention, which includes the LED streetlamp installation seat as shown in FIG. 1.

FIG. 3 is an isometric diagram of the LED streetlamp of FIG. 2, shown from another viewpoint.

### DETAILED DESCRIPTION OF PREFERRED EMBODIMENTS

Reference will now be made to the drawings to describe preferred and exemplary embodiments in details.

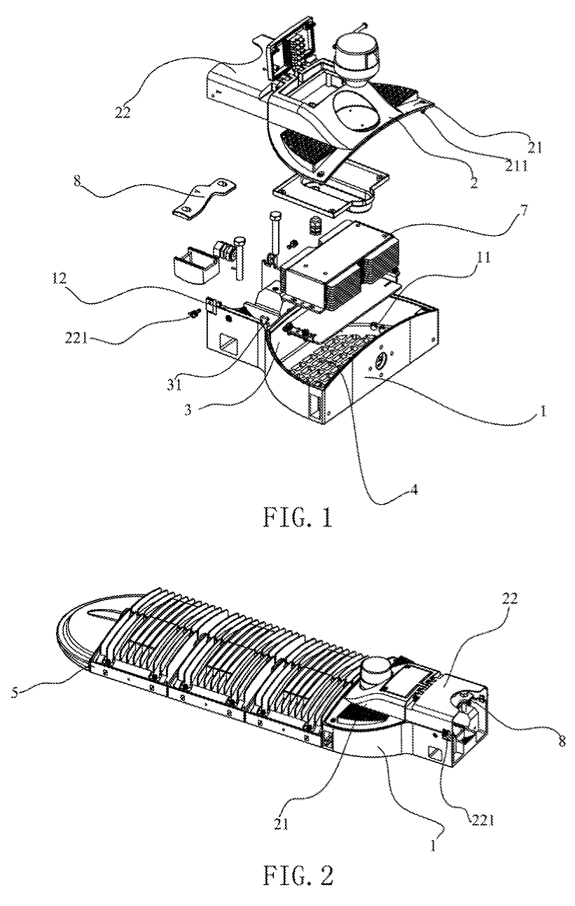

Referring to FIG. 1, an LED streetlamp installation seat according to an embodiment of the present invention is shown. The LED streetlamp installation seat includes a seat body 1. The seat body 1 includes a first accommodating chamber 11 and a second accommodating chamber 12. The first accommodating chamber 11 accommodates a control device 7, that includes an electrical power and/or a PCB and/or other electrical elements, etc. The control device 7 is used to turn-on or turn-off an LED streetlamp. The second accommodating chamber 12 accommodates a fixing device 8, which is used to connect the LED streetlamp to a lamppost and fix it thereon. The seat body 1 further includes a cover cap 2, disposed at a corresponding position of the first and the second accommodating chambers 11, 12. The cover cap 2 is installed at a top opening of the first and the second accommodating chambers 11, 12.

The cover cap 2 includes a first cap 21 and a second cap 22, the first cap 21 being hinge jointed to the second cap 22. Thus, the first cap 21 can rotate respective to the second cap 22.

The first cap 21 is corresponding to the first accommodating chamber 11. A clapboard 3 is provided between the first and the second accommodating chambers 11, 12. The clapboard 3 includes two grooves 31 disposed at one sidewall (not labeled), facing to the first accommodating chamber 11. The two grooves 31 are respectively formed at two sides of the sidewall, adjacent to a connection end of the clapboard 3 and the cover cap 2. The first cap 21 includes two strip-shaped blocks (not shown), corresponding to the two grooves 31. Two fixing screws 211 are respectively provided at two sides of an end of the first cap 21, far away the connection end of the clapboard 3 and the cover cap 2. In the assembly process of the first cap 21 and the first accommodating chamber 11, the two strip-shaped blocks of the first cap 21 respectively insert into the two grooves 21 of the clapboard 3, and the two fixing screws 21 screw into two corresponding screwed holes (not shown) of the first accommodating chamber 11. Thus, the first cap 21 is detachably connected to the first accommodating chamber 11. Obviously, in a deformation embodiment, the two grooves 31 can be formed at a bottom surface of the first cap 21, and the strip-shaped blocks 21 can be disposed at the clapboard 3, corresponding to the two grooves 31 thereof. In a same way, the first cap 21 can be detachably connected to the first accommodating chamber 11 too. In a process of maintaining or repairing the control device 7, a maintainer just needs loosen the two fixing screws 21 for opening of the first cap 21, and turn the first cap 21 upwardly 90 degrees, relative to the second cap 22. Thus, the maintainer can conveniently repair the electrical power or the PCB. After finishing the repairing work, the maintainer just needs downwardly turn the first cap 21 to the first accommodating chamber 11. In the whole repairing process, no need of taking down the second cap 22. Therefore, the repairing process is simple and conveniently, and the efficiency is high.

The second cap 22 is corresponding to the second accommodating chamber 12. The second cap 22 and the second accommodating chamber 12 respectively include two corresponding screw holes (not labeled). When the second cap 22 is connected to the second accommodating chamber 12, two screws 221 are provided to screw into the two respectively screw holes of the second cap 22 and the second accommodating chamber 12. Thus, the second cap 22 is detachably connected to the second accommodating chamber 12. In the process of installing LED streetlamp to the lamppost, an operator just needs to loosen the two screws 221, and turn the second cap 22 upwardly 90 degrees, relative to the first cap 21. And then, the operator can conveniently connect the fixing device 8 and the lamppost. In the whole installation process, no need of taking down the first cap 21. Therefore, the installation process is simple and conveniently, and the efficiency is high. Of course, if there's a need of opening or taking down the first and the second cap 21, 22 at the same time, for convenient installation and reparation, the operator can simultaneously open or take down the first and the second cap 21, 22.

For improving the heat dispersion efficiency, a plurality of through-holes 4 are provided at a bottom surface (not labeled) of the first accommodating chamber 11, which can help to disperse the heat energy from the control device 7 to the atmosphere. Thus, the heat dispersion efficiency can be enhanced, and the lifespan of the control device 7 can be assured.

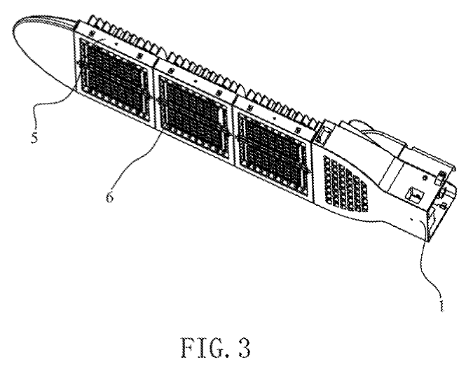

Referring to FIG. 2 and FIG. 3, an LED streetlamp according to a second embodiment of the present invention is shown. The LED streetlamp includes a frame 5, two LED lighting modules 6 accommodated in the frame 5, and an LED streetlamp installation seat disposed at one end of the frame 5. The LED streetlamp installation seat is as the above-described first embodiment. The control device 7 is connected to the LED lighting modules 6, for turning-on or turning-off the LED lighting modules 6. Because the LED streetlamp use the LED streetlamp installation seat, the LED streetlamp has the similar advantage to the LED streetlamp installation seat, such as easier installation, high heat dispersion efficiency and low cost.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. An LED streetlamp installation seat for an LED streetlamp, the LED streetlamp installation seat comprising:
a seat body, comprising a first accommodating chamber and a second accommodating chamber, the first accommodating chamber being used to accommodate a control device for controlling the LED streetlamp, and the second accommodating chamber being used to accommodate a fixing device for installing the LED lamp to a lamppost; and
a cover cap, corresponding to the first and the second accommodating chambers, which comprises a first cap and a second cap, the first cap and the second cap being hinge-joined;
wherein the first cap, corresponding to the first accommodating chamber, is detachably connected to the first accommodating chamber, and the second cap, corresponding to the second accommodating chamber, is detachably connected to the second accommodating chamber.

2. The LED streetlamp installation seat as claimed in claim 1, wherein the first accommodating chamber comprises a plurality of through holes at a bottom surface thereof, for dispersing heat energy from the control device to atmosphere.

3. The LED streetlamp installation seat as claimed in claim 1, wherein the first cap is hinge jointed to the second cap; and a clapboard is provided between the first and the second accommodating chambers, in which the clapboard comprises two grooves at one sidewall facing to the first accommodating chamber, the two grooves being respectively formed at two sides of the sidewall, respectively adjacent to the connection end of the clapboard and the cover cap; and two strip-shaped blocks are provided at the first cap, corresponding to the two grooves, thus the first cap being detachably connected to the first accommodating chamber through the two strip-shaped blocks inserting into the two grooves, respectively; and two screw holes are provided at two sides of the second cap, thus the second cap being detachably connected to the second accommodating chamber through the cooperation of two screws and the two screw holes, respectively.

4. The LED streetlamp installation seat as claimed in claim 1, wherein the first cap is hinge jointed to the second cap; and a clapboard is provided between the first and the second accommodating chambers, in which the clapboard comprises two strip-shaped blocks at one sidewall facing to the first accommodating chamber, the two strip-shaped blocks being respectively formed at two sides of the sidewall, respectively adjacent to the connection end of the clapboard and the cover cap; and two grooves are provided at the first cap, corresponding to the two strip-shaped blocks, thus the first cap being detachably connected to the first accommodating chamber through the two strip-shaped blocks inserting into the two grooves, respectively; and two screw holes are provided at two sides of the second cap, thus the second cap being detachably connected to the second accommodating chamber through the cooperation of two screws and the two screw holes, respectively.

5. An LED streetlamp comprising:
a frame;
an LED lighting module formed on the frame; and
an LED streetlamp installation seat, disposed at an end of the frame, the LED streetlamp installation seat comprising:
a seat body, comprising a first accommodating chamber and a second accommodating chamber, the first accommodating chamber being used to accommodate a control device for controlling the LED streetlamp, and the second accommodating chamber being used to accommodate a fixing device for installing the LED lamp to a lamp-post; and
a cover cap, corresponding to the first and the second accommodating chambers, which comprises a first cap and a second cap, the first cap and the second cap being hinge joined;
wherein the first cap, corresponding to the first accommodating chamber, is detachably connected to the first accommodating chamber, and the second cap, corresponding to the second accommodating chamber, is detachably connected to the second accommodating chamber.

6. The LED streetlamp installation seat as claimed in claim 2, wherein the first cap is hinge jointed to the second cap; and a clapboard is provided between the first and the second accommodating chambers, in which the clapboard comprises two grooves at one sidewall facing to the first accommodating chamber, the two grooves being respectively formed at two sides of the sidewall, respectively adjacent to the connection end of the clapboard and the cover cap; and two strip-shaped blocks are provided at the first cap, corresponding to the two grooves, thus the first cap being detachably connected to the first accommodating chamber through the two strip-shaped blocks inserting into the two grooves, respectively; and two screw holes are provided at two sides of the second cap, thus the second cap being detachably connected to the second accommodating chamber through the cooperation of two screws and the two screw holes, respectively.

7. The LED streetlamp installation seat as claimed in claim 2, wherein the first cap is hinge jointed to the second cap; and a clapboard is provided between the first and the second accommodating chambers, in which the clapboard comprises two strip-shaped blocks at one sidewall facing to the first accommodating chamber, the two strip-shaped blocks being respectively formed at two sides of the sidewall, respectively adjacent to the connection end of the clapboard and the cover cap; and two grooves are provided at the first cap, corresponding to the two strip-shaped blocks, thus the first cap being detachably connected to the first accommodating chamber through the two strip-shaped blocks inserting into the two grooves, respectively; and two screw holes are provided at two sides of the second cap, thus the second cap being detachably connected to the second accommodating chamber through the cooperation of two screws and the two screw holes, respectively.

8. The LED streetlamp as claimed in claim 7, wherein the first accommodating chamber comprises a plurality of through holes at a bottom surface thereof, for dispersing heat energy from the control device to atmosphere.
